(19) United States
(12) Patent Application Publication
(10) Pub. No.: US 2018/0327224 A1
(43) Pub. Date: Nov. 15, 2018

(54) ELECTRONIC SAFETY ACTUATOR

(71) Applicant: Otis Elevator Company, Farmington, CT (US)

(72) Inventors: Justin BILLARD, Amston, CT (US); Guohong HU, Farmington, CT (US); Daryl J. MARVIN, Farmington, CT (US)

(21) Appl. No.: 15/777,544

(22) PCT Filed: Nov. 21, 2016
(86) PCT No.: PCT/US2016/063187

§ 371 Date: May 18, 2018

Related U.S. Application Data
(60) Provisional application No. 62/258,140, filed on Nov. 20, 2015.

(51) Int. Cl. B66B 5/22; B66B 9/00

(52) U.S. Cl. CPC B66B 5/22; B66B 9/00

(57) ABSTRACT

The present disclosure relates generally to a selectively operable magnetic braking system having a safety brake adapted to arrest movement when moved from a non-braking state into a braking state, a magnetic brake configured to move between an engaging position and a non-engaging position, the magnetic brake, when in the engaging position, moving the safety brake from the non-braking state into the braking state, and an electromagnetic component configured to hold the magnetic brake with a hold power in the non-engaging position.

### CROSS-REFERENCE TO RELATED APPLICATION

The present application is an international patent application, which claims priority to 62/258,140, filed Nov. 20, 2016, which is herein incorporated in its entirety.

### TECHNICAL FIELD OF THE DISCLOSED EMBODIMENTS

The present disclosure is generally related to braking and/or safety systems and, more specifically, an electronic safety actuator.

### BACKGROUND OF THE DISCLOSED EMBODIMENTS

Some machines, such as an elevator system, include a safety system to stop the machine when it rotates at excessive speeds or the elevator cab travels at excessive speeds in response to an inoperative component. Conventional safety systems include an actively applied safety system that requires power to positively actuate the safety mechanism or a passively applied safety system that requires power to maintain the safety system in a hold operating state. Although passively applied safety systems offer an increase in functionality, such systems typically require a significant amount of power in order to maintain the safety system in a hold operating state, thereby greatly increasing energy requirements and operating costs of the machine. Further, passively applied safety systems typically feature larger components due to the large power requirements during operation, which adversely affects the overall size, weight, and efficiency of the machine. There is therefore a need for a more robust safety system with reduced complexity and power requirements for reliable operation.

### SUMMARY OF THE DISCLOSED EMBODIMENTS

In one aspect, a selectively operable braking device for an elevator system including a car and a guide rail is provided. The braking device includes a safety brake disposed on the car and adapted to be wedged against the guide rail when moved from a non-braking state into a braking state, a rod operably coupled to the safety brake, the rod configured to move the safety brake between the non-braking state and braking state, a magnetic brake operably coupled to the rod and disposed adjacent to the guide rail, the magnetic brake configured to move between an engaging position and a non-engaging position, the magnetic brake, when in the engaging position contemporaneously with motion of the car, moving the rod in a direction to thereby move the safety brake from the non-braking state into the braking state, and an electromagnetic component. The electromagnetic component is configured to hold the magnetic brake with a hold power in the non-engaging position.

In an embodiment, the braking device further includes a safety controller in electrical communication with the electromagnetic component, the safety controller configured to control the hold power. In any of the embodiments, the electromagnetic component is configured to release the magnetic brake into the engaging position upon at least one of reduction and elimination of the hold power. In any of the embodiments, the hold power cooperates with a magnetic attraction of the magnetic brake to the electromagnetic component to hold the magnetic brake in the non-engaging position.

In any of the above embodiments, the braking device further includes a biasing member configured to move the magnetic brake in a direction parallel to an actuation axis into the engaging position. In any of the above embodiments, the braking device further includes a shim member disposed between the magnetic brake and the electromagnetic component, the shim member having a thickness greater than a distance between the magnetic brake and the guide rail when the magnetic brake is in the rail-non-engaging position. In any of the above embodiments, the electromagnetic component includes an electromagnetic component contact area configured to contact the magnetic brake, the magnetic brake includes a magnetic brake contact area configured to contact the guide rail, the magnetic brake contact area being greater than the electromagnetic component contact area. In any of the embodiments, the safety controller is further configured to increase the hold power to return the magnetic brake to the rail-non-engaging position following the at least one of reduction and elimination of the hold power.

In another aspect of the present disclosure, a selectively operable magnetic braking system is provided. The braking system includes a safety brake disposed on a machine and adapted to arrest movement of the machine when moved from a non-braking state into a braking state, a magnetic brake disposed adjacent to the machine, the magnetic brake configured to move between an engaging position and a non-engaging position, the magnetic brake, when in the engaging position contemporaneously with motion of the machine, moving to thereby move the safety brake from the non-braking state into the braking state, and an electromagnetic component configured to hold the magnetic brake with a hold power in the non-engaging position.

In an embodiment, the braking system further includes a safety controller in electrical communication with the electromagnetic component, the safety controller configured to control the hold power. In any of the embodiments, the electromagnetic component is configured to release the magnetic brake into the engaging position upon at least one of reduction and elimination of the hold power. In any of the embodiments, the hold power cooperates with a magnetic attraction of the magnetic brake to the electromagnetic component to hold the magnetic brake in the non-engaging position.

In any of the above embodiments, the braking system further includes a biasing member configured to move the magnetic brake in a direction parallel to an actuation axis into the engaging position. In any of the above embodiments, the braking system further includes a shim member disposed between the magnetic brake and the electromagnetic component, the shim member having a thickness greater than a distance of travel of the magnetic brake between the engaging position and the non-engaging position along a direction parallel to an actuation axis. In any of the above embodiments, the electromagnetic component includes an electromagnetic component contact area configured to contact the magnetic brake, the magnetic brake includes a magnetic brake contact area at a side opposite from the electromagnetic component, the magnetic brake contact area being greater than the electromagnetic component contact area. In any of the embodiments, the safety controller is further configured to increase the hold power to return the magnetic brake to the non-engaging position following the at least one of reduction and elimination of the hold power.

In another aspect of the present disclosure, an elevator system is provided. The elevator system includes a hoistway, a guide rail disposed in the hoistway, a car operably coupled to the guide rail by a car frame for upward and downward travel in the hoistway, a safety brake disposed on the car and adapted to be wedged against the guide rail when moved from a non-braking state into a braking state, a rod operably coupled to the safety brake, the rod configured to move the safety brake between the non-braking state and braking state, a magnetic brake operably coupled to the rod and disposed adjacent to the guide rail, the magnetic brake configured to move between an engaging position and a non-engaging position, the magnetic brake, when in the engaging position contemporaneously with motion of the car, moving the rod in a direction to thereby move the safety brake from the non-braking state into the braking state, and an electromagnetic component, wherein the electromagnetic component is configured to hold the magnetic brake with a hold power in the non-engaging position.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of an elevator system employing a mechanical governor;

FIG. 2 is a schematic cross-sectional view of an electronic safety actuator in a non-engaging position according to an embodiment of the present disclosure;

FIG. 3 is a schematic side view of the electronic safety actuator in an engaging position according to an embodiment of the present disclosure;

FIG. 4 is a schematic cross-sectional view of the electronic safety actuator in an engaging position according to an embodiment of the present disclosure;

FIG. 5 is a schematic cross-sectional view of an electronic safety actuator in a non-engaging position according to an embodiment of the present disclosure;

FIG. 6 is a schematic side elevation view of an electronic safety actuator according to an embodiment of the present disclosure;

FIG. 7 is a schematic cross-sectional view of the electronic safety actuator of FIG. 6 in a non-engaging position according to an embodiment of the present disclosure;

FIG. 8 is a schematic cross-sectional view of an electronic safety actuator in a non-engaging position according to an embodiment of the present disclosure; and

FIG. 9 is a schematic cross-sectional view of an electronic safety actuator in a non-engaging position according to an embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

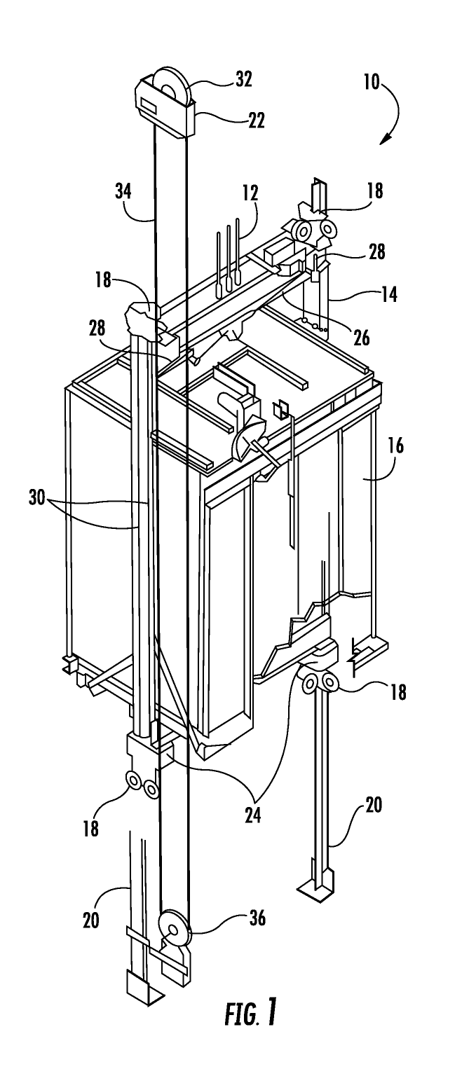

FIG. 1 shows an elevator system, generally indicated at 10. The elevator system 10 includes cables 12, a car frame 14, a car 16, roller guides 18, guide rails 20, a governor 22, safeties 24, linkages 26, levers 28, and lift rods 30. Governor 22 includes a governor sheave 32, rope loop 34, and a tensioning sheave 36. Cables 12 are connected to car frame 14 and a counterweight (not shown in FIG. 1) inside a hoistway. Car 16, which is attached to car frame 14, moves up and down the hoistway by force transmitted through cables 12 to car frame 14 by an elevator drive (not shown) commonly located in a machine room at the top of the hoistway. Roller guides 18 are attached to car frame 14 to guide the car 16 up and down the hoistway along guide rail 20. Governor sheave 32 is mounted at an upper end of the hoistway. Rope loop 34 is wrapped partially around governor sheave 32 and partially around tensioning sheave 36 (located in this embodiment at a bottom end of the hoistway). Rope loop 34 is also connected to elevator car 16 at lever 28, ensuring that the angular velocity of governor sheave 32 is directly related to the speed of elevator car 16.

In the elevator system 10 shown in FIG. 1, governor 22, an electromechanical brake (not shown) located in the machine room, and safeties 24 act to stop elevator car 16 if car 16 exceeds a set speed as it travels inside the hoistway. If car 16 reaches an over-speed condition, governor 22 is triggered initially to engage a switch, which in turn cuts power to the elevator drive and drops the brake to arrest movement of the drive sheave (not shown) and thereby arrest movement of car 16. If, however, cables 12 break or car 16 otherwise experiences a free-fall condition unaffected by the brake, governor 22 may then act to trigger safeties 24 to arrest movement of car 16. In addition to engaging a switch to drop the brake, governor 22 also releases a clutching device that grips the governor rope 34. Governor rope 34 is connected to safeties 24 through mechanical linkages 26, levers 28, and lift rods 30. As car 16 continues its descent unaffected by the brake, governor rope 34, which is now prevented from moving by actuated governor 22, pulls on operating lever 28. Operating lever 28 “sets” safeties 24 by moving linkages 26 connected to lift rods 30, which lift rods 30 cause safeties 24 to engage guide rails 20 to bring car 16 to a stop.

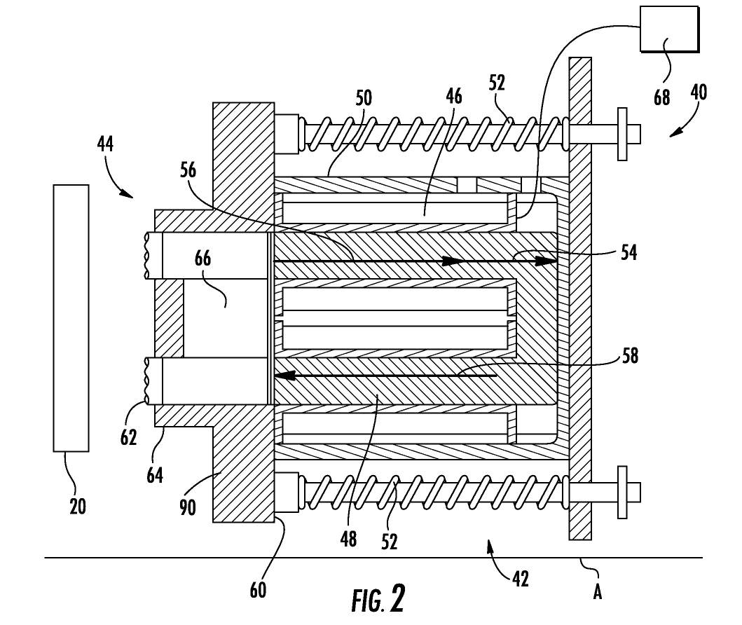

FIG. 2 shows an embodiment of an electronic safety actuator 40 for an elevator safety system in a non-engaging position. The electronic safety actuator 40 includes an electromagnetic component 42 and a magnetic brake 44. The electromagnetic component 42 includes a coil 46 and a core 48 disposed within a housing 50. A safety controller 68 is in electrical communication with the electromagnetic component 42 and is configured to control a supply of electricity to the electromagnetic component 42. In the embodiment shown, the electronic safety actuator 40 further includes at least one biasing member 52. The embodiment of FIG. 2 illustrates two biasing members 52 configured to provide a repulsion force 58 to move the magnetic brake 44 in a direction parallel to an actuation axis A. The biasing members 52 of an embodiment are compression springs. The magnetic brake 44 includes a first end 60, a holder 90, and a brake portion 62 disposed on a second end 64. A magnet 66 is disposed within or adjacent to the magnetic brake 44 and configured to magnetically couple the magnetic brake 44 to the electromagnetic component 42 in a non-engaging position and to a ferromagnetic or paramagnetic component of the system (e.g. the guide rails 20) in an engaging position. The electromagnetic component 42 is configured to hold the magnetic brake 44 in the non-engaging position with a hold power 54. The magnetic brake 44 provides a magnetic attraction force 56 in a direction toward the electromagnetic component 42 to further hold the magnetic brake 44 in the non-engaging position.

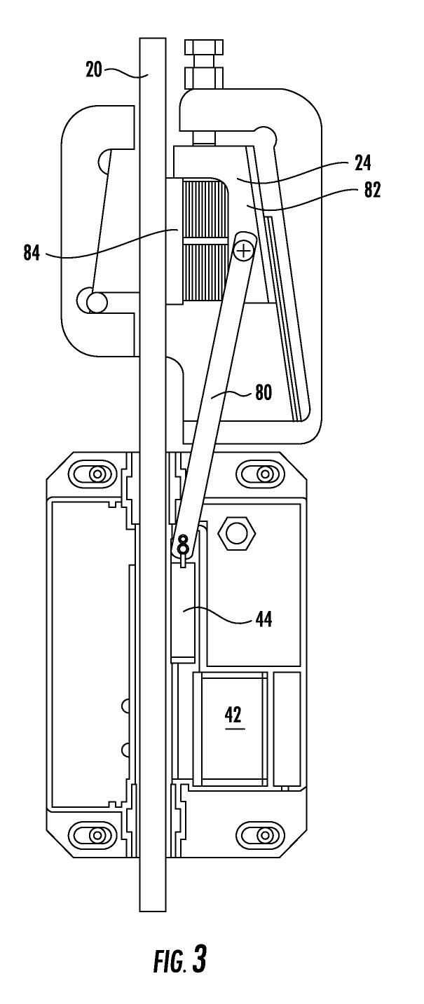

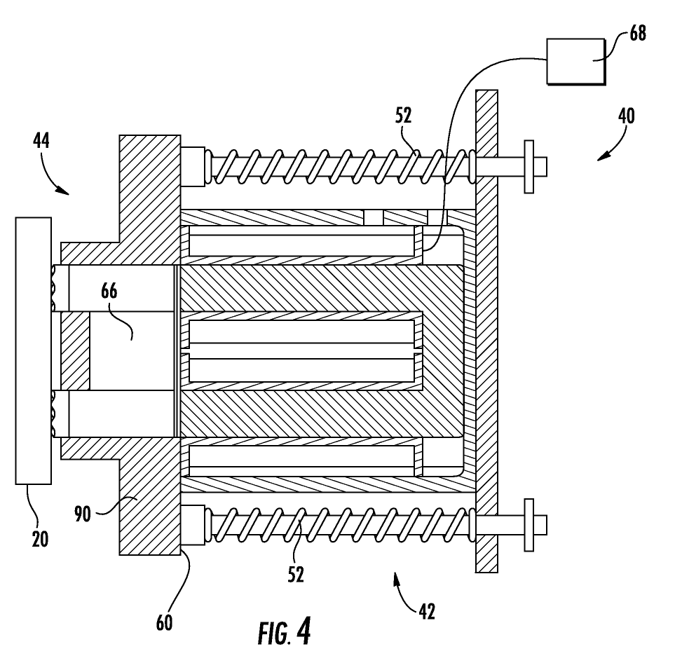

For example, in the non-engaging position illustrated in FIG. 2, the magnetic brake 44 is attracted and held to the electromagnetic component 42 with the hold power 54 via the core 48 when the safety controller 68 supplies electrical energy to the coil 46 of the electromagnetic component 42. Additionally, the magnetic attraction force 56 of the magnetic brake 44 to the electromagnetic component 42 combines with the hold power 54 in an additive fashion to hold the magnetic brake 44 in the non-engaging position. In the embodiment of FIG. 2, biasing members 52 provide the repulsion force 58 to oppose the combined magnetic attraction force 56 and hold power 54. In an embodiment, the hold power 54 is relatively low. The hold power 54 of the embodiment illustrated is lower than each of the magnetic attraction force 56 and the repulsion force 58. In the embodiment, the repulsion force 58 is larger than the magnetic attraction force 56, but the combination of the magnetic attraction force 56 and the hold power 54 exceeds the repulsion force 58 to maintain the magnetic brake 44 in the non-engaging position. In an embodiment, the safety controller 68 is configured to reduce the hold power 54 by reducing the amount of electrical energy supplied to the electromagnetic component 42 upon, for example, the identification of an overspeed condition, as described below. Upon reduction of the hold power 54, the electromagnetic component 42 is configured to release the magnetic brake 44 into an engaging position, as illustrated in FIGS. 3 and 4 and described further below.

In the event of an overspeed condition of elevator car 16 in the down direction, the controller 68 reduces or eliminates the hold power 54 of electromagnetic component 42 by reducing or eliminating the amount of electrical energy supplied to the electromagnetic component 42. As a result, the repulsion force 58 exerted by the biasing members 52 is now large enough to propel the magnetic brake 44 towards the guide rail 20 into a rail-engaging position, as shown in FIGS. 3 and 4.

In the rail-engaging position illustrated in FIGS. 3 and 4, the magnetic brake 44 is magnetically attached to the guide rail 20. FIG. 3 illustrates the attached magnetic brake 44 positioned above the electromagnetic component 42 after moving upward with the guide rail 20 relative to the descending elevator car 16. The magnetic brake 44 is operably coupled to the safety brake 24 by a rod or small linkage bar 80, as illustrated in FIG. 3. The magnetic brake 44, in the rail-engaging position, pushes the safety brake 24 in an upward direction due to the relative upward movement of the magnetic brake 44 relative to the descending elevator car 16. The safety brake 24 engages the guide rail 20 when the magnetic brake 44 pushes the safety brake 24 in the upward direction. A wedge-shaped portion 82 of the safety brake 24 allows a safety brake pad 84 to move toward and engage with the guide rail 20 upon upward movement of the magnetic brake 44 and the rod 80, as illustrated in FIG. 3.

In a further embodiment not illustrated, the electronic safety actuator 40 and the safety brake 24 are integrated into a single assembly. In one embodiment not illustrated, the rod or small linkage bar 80 is eliminated in a single assembly of the electronic safety actuator 40 and the safety brake 24. Once ready to return to the non-engaging position, the car 16 is moved upward to allow resetting of the electronic safety actuator 40 and the safety brake 24. From the engaging position, the magnetic brake 44 returns to the non-engaging position upon operating the safety controller 68 to increase or switch on the hold power 54 to the electromagnetic component 42.

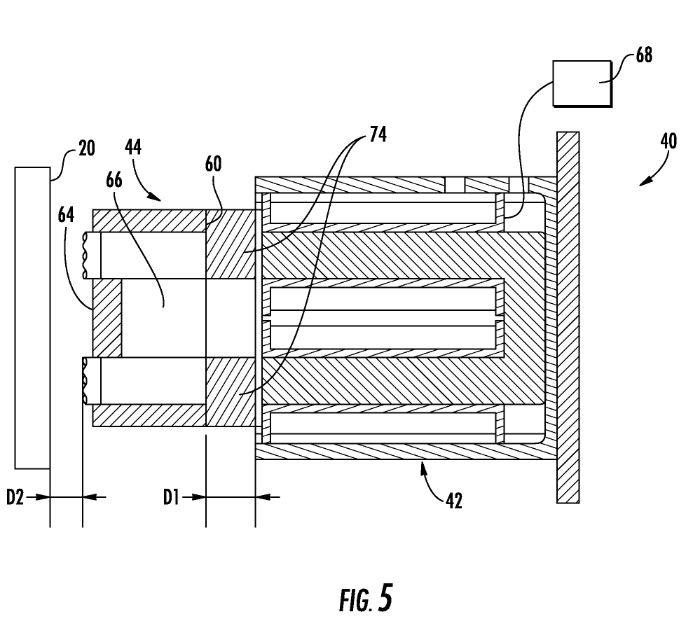

Referring now to FIG. 5, an embodiment of the electronic safety actuator 40 includes at least one shim member 74 disposed between the magnetic brake 44 and the electromagnetic component 42. The magnetic brake 44 includes the holder 90 and the magnet 66. The shim member 74 of one or more embodiments is composed of non-magnetic material. The shim member 74 separates the magnetic brake 44 from the electromagnetic component 42 by a nominal first distance D1, and places the magnetic brake 44 within a nominal second distance D2 from the guide rail 20. In an embodiment, the first distance D1 is larger than the second distance D2. As a result, when the hold power 54 exerted by the electromagnetic component 42 is reduced or eliminated, the magnetic brake 44 is propelled toward the guide rail 20 as a result of the second end 64 being closer to the guide rail 20 as compared to the first end 60 to the electromagnetic component 42. This differential distance of D1-D2 creates the repulsion force 58, similar to the repulsion force 58 exerted by the biasing members 52 in FIGS. 3 and 4, to propel the magnetic brake 44 towards the guide rail 20 into the rail-engaging position. To separate the magnetic brake 44 from the electromagnetic component 42 by the first distance D1, the shim member 74 has a thickness equal to D1. From the engaging position, the magnetic brake 44 returns to the non-engaging position upon operating the safety controller 68 to increase or switching on the hold power 54 to the electromagnetic component 42.

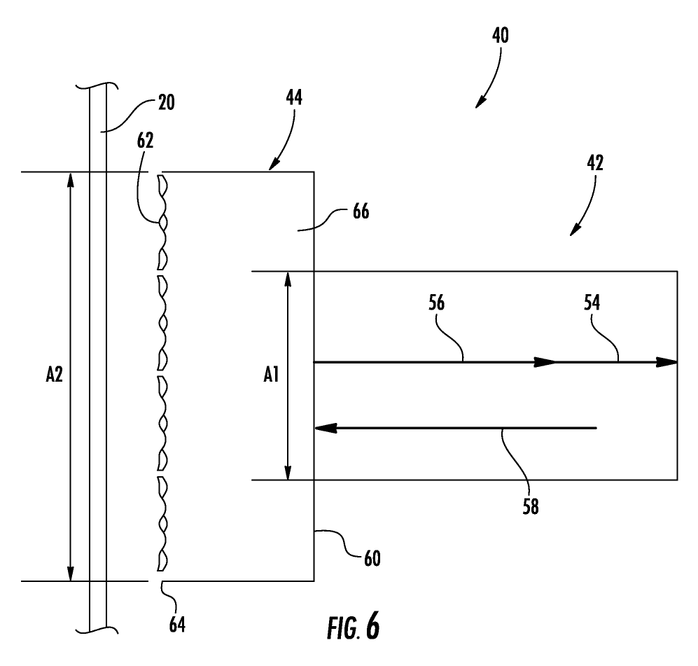

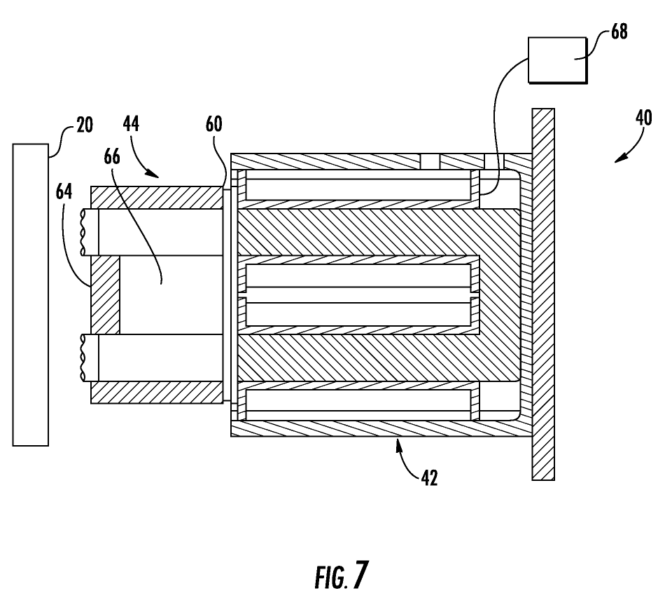

Referring now to FIGS. 6 and 7, an embodiment of the electronic safety actuator 40 is shown. FIG. 6 is a side schematic view of the electronic safety actuator 40, and FIG. 7 is a top schematic view illustrating the electromagnetic component 42 and the magnetic brake 44 having the holder 90 and the magnet 66. As illustrated in FIG. 6, the electromagnetic component 42 has an electromagnetic component contact area A1 configured to contact the magnetic brake 44. The electromagnetic component contact area A1 occupies only a portion of the larger surface of the first end 60 of the magnetic brake 44. Therefore, the magnetic attraction force 56 of contact area A1 is proportional to the surface area of the electromagnetic component 42. As illustrated in the side view of FIG. 6, the magnetic brake 44 includes a magnetic brake contact area A2 configured to contact the guide rail 20. The magnetic brake contact area A2 contacts the guide rail 20 across a much larger surface area as compared to the contact area A1. A larger magnetic contact area will generally result in a larger magnetic force between the contact area and the adjacent ferromagnetic or paramagnetic object. The magnetic brake contact area A2 is greater than the electromagnetic component contact area A1 to provide the repulsion force 58 of the magnetic brake 44 toward the guide rail 20. The differential contact area of A2-A1 creates the repulsion force 58, similar to the repulsion force 58 exerted by the biasing members 52 in FIGS. 3 and 4 and the differential distance D2-D1 in FIG. 5, to propel the magnetic brake 44 towards the guide rail 20 into the rail-engaging position. Similar to the embodiments described above, when the hold power 54 exerted by the electromagnetic component 42 is reduced or eliminated, the magnetic brake 44 is propelled toward the guide rail 20 as a result of the electromagnetic component contact area Al at the first end 60 being smaller than the magnetic brake contact area A2 at the second end 64. From the engaging position, the magnetic brake 44 returns to the non-engaging position upon operating the safety controller 68 to increase or switching on the hold power 54 to the electromagnetic component 42.

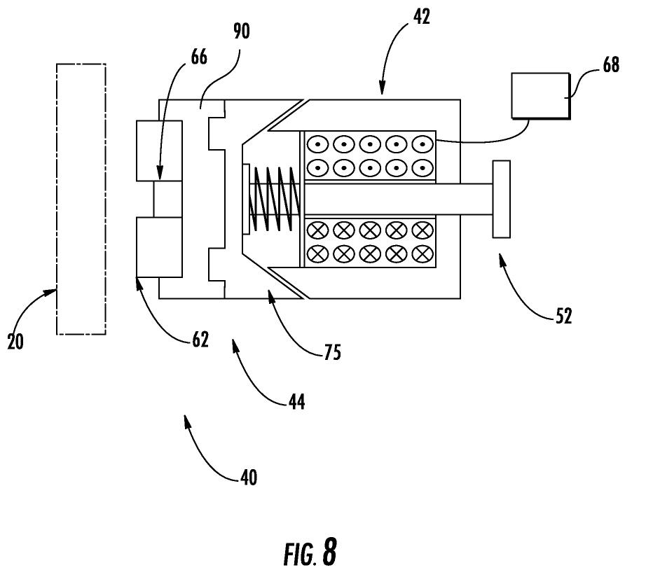

Referring now to FIG. 8, an embodiment of the electronic safety actuator 40 includes a member 75 disposed between a magnetic brake 44 and an electromagnetic component 42. In an embodiment, the member 75 is a movable ferromagnetic plate, as illustrated in FIG. 8. A holder 90 is disposed between the member 75 and a magnet 66. In an embodiment, the holder 90 includes a non-magnetic material, and the magnetic brake 44 includes a ferromagnetic or paramagnetic material. A biasing member 52 extends through a central location of the electromagnetic component 42. In an embodiment, the biasing member 52 is a movable plunger. FIG. 8 illustrates the electronic safety actuator 40 in a non-engaging position. Similar to the embodiments described above, when a hold power 54 exerted by the electromagnetic component 42 is reduced or eliminated, the magnetic brake 44 is propelled toward the guide rail 20 as a result of the biasing member 52. From the engaging position, the magnetic brake 44 returns to the non-engaging position upon operating the safety controller 68 to increase or switching on the hold power 54 to the electromagnetic component 42.

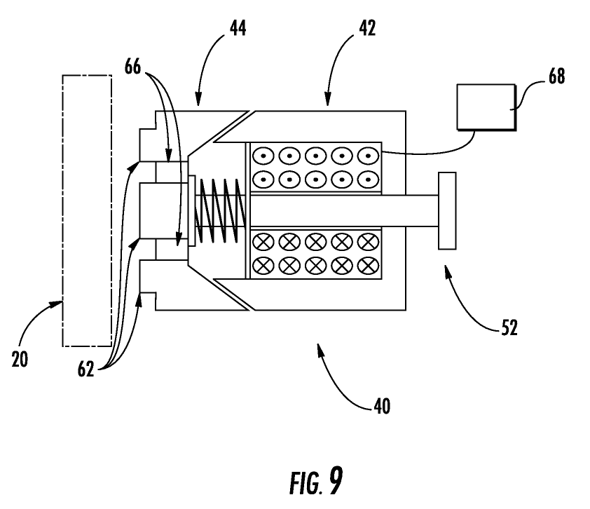

Referring now to FIG. 9, an embodiment of the electronic safety actuator 40 includes a magnetic brake 44 spaced from an electromagnetic component 42. The magnetic brake 44 includes a ferromagnetic or paramagnetic material in an embodiment and includes at least one magnet 66. The biasing member 52 extends through a central location of the electromagnetic component 42 as illustrated in FIG. 9. In an embodiment, the biasing member 52 is a movable plunger to move the magnetic brake 44 into contact with the guide rail 20. FIG. 9 illustrates the electronic safety actuator 40 in a non-engaging position. Similar to the embodiments described above, when a hold power 54 exerted by the electromagnetic component 42 is reduced or eliminated, the magnetic brake 44 is propelled toward the guide rail 20 as a result of the biasing member 52. From the engaging position, the magnetic brake 44 returns to the non-engaging position upon operating the safety controller 68 to increase or switching on the hold power 54 to the electromagnetic component 42.

While the embodiments of the electronic safety actuator 40 are shown in use with an elevator system 10, it will be appreciated that the electronic safety actuator 40 may be suitable for any large stroke range application, such as a rotary arrangement and linear arrangement machines to name a couple of non-limiting example.

The present disclosure includes the benefit of ensuring actuation of the electronic safety actuator 40 when the elevator system 10 loses power. The inclusion of the passive magnet 66 to help overcome the repulsion force 58 reduces the amount of electrically-induced hold power 54 required. Because the hold power 54 is provided over a long operational duration while the safety actuator 40 is in the non-engaging position, and the hold power 54 of the illustrated embodiments of the present disclosure is low, the electronic safety actuator 40 of the present disclosure reduces operation power requirements while maintaining optimal functionality. Further, because the power to maintain the non-engaging position of the electronic safety actuator 40 is reduced, smaller electromagnetic components may be used to supply power and dissipate heat. The smaller components of the present embodiments allow for a more compact assembly while increasing machine efficiency by reducing overall system weight.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. A selectively operable braking device for an elevator system including a car and a guide rail, comprising:
a safety brake disposed on the car and adapted to be wedged against the guide rail when moved from a non-braking state into a braking state;
a rod operably coupled to the safety brake, the rod configured to move the safety brake between the non-braking state and braking state;
a magnetic brake operably coupled to the rod and disposed adjacent to the guide rail, the magnetic brake configured to move between an engaging position and a non-engaging position, the magnetic brake, when in the engaging position contemporaneously with motion of the car, moving the rod in a direction to thereby move the safety brake from the non-braking state into the braking state; and
an electromagnetic component, wherein the electromagnetic component is configured to hold the magnetic brake with a hold power in the non-engaging position.

2. The braking device of claim 1 further comprising:
a safety controller in electrical communication with the electromagnetic component, the safety controller configured to control the hold power.

3. The braking device of claim 1, wherein the electromagnetic component is configured to release the magnetic brake into the engaging position upon at least one of reduction and elimination of the hold power.

4. The braking device claim 1, wherein the hold power cooperates with a magnetic attraction of the magnetic brake to the electromagnetic component to hold the magnetic brake in the non-engaging position.

5. The braking device of claim 1, further comprising a biasing member configured to move the magnetic brake in a direction parallel to an actuation axis into the engaging position.

6. The braking device of claim 1, further comprising a shim member disposed between the magnetic brake and the electromagnetic component, the shim member having a thickness greater than a distance between the magnetic brake and the guide rail when the magnetic brake is in the rail-non-engaging position.

7. The braking device of claim 1, wherein the electromagnetic component includes an electromagnetic component contact area configured to contact the magnetic brake, the magnetic brake includes a magnetic brake contact area configured to contact the guide rail, the magnetic brake contact area being greater than the electromagnetic component contact area.

8. The braking device of claim 3, wherein the safety controller is further configured to increase the hold power to return the magnetic brake to the rail-non-engaging position following the at least one of reduction and elimination of the hold power.

9. A selectively operable magnetic braking system comprising:
a safety brake disposed on a machine and adapted to arrest movement of the machine when moved from a non-braking state into a braking state;
a magnetic brake disposed adjacent to the machine, the magnetic brake configured to move between an engaging position and a non-engaging position, the magnetic brake, when in the engaging position contemporaneously with motion of the machine, moving to thereby move the safety brake from the non-braking state into the braking state; and
an electromagnetic component configured to hold the magnetic brake with a hold power in the non-engaging position.

10. The magnetic braking system of claim 9 further comprising:
a safety controller in electrical communication with the electromagnetic component, the safety controller configured to control the hold power.

11. The magnetic braking system of claim 9, wherein the electromagnetic component is configured to release the magnetic brake into the engaging position upon at least one of reduction and elimination of the hold power.

12. The magnetic braking system of claim 9, wherein the hold power cooperates with a magnetic attraction of the magnetic brake to the electromagnetic component to hold the magnetic brake in the non-engaging position.

13. The magnetic braking system of claim 9, further comprising a biasing member configured to move the magnetic brake in a direction parallel to an actuation axis into the engaging position.

14. The magnetic braking system of any of claim 9, further comprising a shim member disposed between the magnetic brake and the electromagnetic component, the shim member having a thickness greater than a distance of travel of the magnetic brake between the engaging position and the non-engaging position along a direction parallel to an actuation axis.

15. The magnetic braking system of claim 9, wherein the electromagnetic component includes an electromagnetic component contact area configured to contact the magnetic brake, the magnetic brake includes a magnetic brake contact area at a side opposite from the electromagnetic component, the magnetic brake contact area being greater than the electromagnetic component contact area.

16. The magnetic braking system of claim 11, wherein the safety controller is further configured to increase the hold power to return the magnetic brake to the non-engaging position following the at least one of reduction and elimination of the hold power.

17. An elevator system comprising:
a hoistway;
a guide rail disposed in the hoistway;
a car operably coupled to the guide rail by a car frame for upward and downward travel in the hoistway;
a safety brake disposed on the car and adapted to be wedged against the guide rail when moved from a non-braking state into a braking state;
a rod operably coupled to the safety brake, the rod configured to move the safety brake between the non-braking state and braking state;
a magnetic brake operably coupled to the rod and disposed adjacent to the guide rail, the magnetic brake configured to move between an engaging position and a non-engaging position, the magnetic brake, when in the engaging position contemporaneously with motion of the car, moving the rod in a direction to thereby move the safety brake from the non-braking state into the braking state; and
an electromagnetic component, wherein the electromagnetic component is configured to hold the magnetic brake with a hold power in the non-engaging position.
